(19) United States
(12) Patent Application Publication
(10) Pub. No.: US 2022/0328881 A1
(43) Pub. Date: Oct. 13, 2022

(54) Electrolyte Enabling Stable Extended Cycling Under Extreme Conditions

(71) Applicant: United States Department of Energy, Washington, DC (US)

(72) Inventors: Esther S. Takeuchi, South Setauket, NY (US); Kenneth J. Takeuchi, South Setauket, NY (US); Amy C. Marschilok, Stony Brook, NY (US); David C. Bock, Shoreham, NY (US)

(21) Appl. No.: 17/718,512

(22) Filed: Apr. 12, 2022

Related U.S. Application Data
(60) Provisional application No. 63/173,642, filed on Apr. 12, 2021.

(51) Int. Cl. H01M 10/0569; H01M 10/0525; H01M 10/0568; H01M 10/0567

(52) U.S. Cl. CPC H01M 10/0569; H01M 10/0525; H01M 10/0568; H01M 10/0567

(57) ABSTRACT

One or more embodiments relates to a solvent that includes a first fluorinated ester, a diluent, a salt. One or more embodiments may include a film-forming additive. The diluent may include a second fluorinated ester or a fluorinated ether. Further, the solvent to diluent ratio is from about 1:0.2 to about 1:10.

### CROSS-REFERENCE TO RELATED APPLICATION

This Application claims the benefit of and priority to U.S. Provisional Patent Application 63/173,642 filed Apr. 12, 2021, the complete subject of which is incorporated herein in its entirety.

### STATEMENT OF GOVERNMENT SUPPORT

The United States Government has rights in this invention pursuant to the employer-employee relationship of the Government to the inventors as U.S. Department of Energy employees and site-support contractors at the Brookhaven National Laboratory.

### FIELD OF THE INVENTION

Embodiments relate to solvents and batteries with electrolytes. More specifically embodiments relate to solvents and batteries with electrolytes having a solvent that includes a first fluorinated ester, a diluent, a salt, and may contain a film-forming additive. The diluent may include a second fluorinated ester or a fluorinated ether. Further, the solvent to diluent ratio is from about 1:0.2 to about 1:10.

### BACKGROUND

Li-ion batteries (LIBs) are increasingly required to operate under a broad range of operational conditions pushing the limits of the current state of the art of batteries. Extreme conditions of high operating voltage, wide temperature range, fast charge, and intense abuse present problems with stability and safety, primarily due to the limitations of traditional Li-ion carbonate-based electrolytes. Thus, there is a critical need to develop novel electrolytes with enhanced functionality under this diverse set of environments and operating parameters.

A need exists in the art for an electrolyte that includes a first fluorinated ester, a diluent, and a salt. The electrolyte may contain a film-forming additive. The diluent may include a second fluorinated ester or a fluorinated ether. Further, the solvent to diluent ratio is from about 1:0.2 to about 1:10.

### SUMMARY

One embodiment is related to an electrolyte that includes a first fluorinated ester, a diluent, and a salt. The electrolyte may contain a film-forming additive. The diluent may include a second fluorinated ester. Further, the solvent to diluent ratio is from about 1:0.2 to about 1:10.

Another embodiment is related to a lithium-ion battery including an electrolyte. The electrolyte includes a solvent comprising a first fluorinated ester; a diluent; and an at least one of a salt and a film-forming additive.

In one or more embodiments, the first fluorinated ester is selected from ethyl 2,2,2-trifluoroacetate (ETFA), methyl 3,3,3-triflouropropionate (MTFP), 2,2,2-trifluoroethyl acetate (TFEA), and 2,2,2-trifluoroethylbutyrate (TFEB). The diluent may be a second fluorinated ester, selected from 2,2,3,3-tetrafluoropropyl trifluoroacetate (TFPTFA) or 1,1,1,3,3,3-hexafluoroisopropyl trifluoroacetate (HFITFA). The diluent may also be a fluorinated ether, selected from 1,1,2,2-tetrafuoroethyl 2,2,2-trifuoroethyl ether (TFETFE) and 1H, 1H, 5H-octafluoropentyl 1,1,2,2-tetrafluoroethyl ether (OFPTFE). The salt is selected from lithium hexafluorophosphate (LiPF₆) or lithium bis(fluorosulfonyl)imide LiFSI. The film-forming additive is selected from fluoroethylene carbonate (FEC) or vinylene carbonate (VC).

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 depicts fluorinated esters for use as solvents: ethyl 2,2,2-trifluoroacetate (ETFA), methyl 3,3,3-triflouropropionate (MTFP), 2,2,2-trifluoroethylacetate (TFEA), and 2,2,2-trifluoroethylbutyrate (TFEB) in accordance with one embodiment;

FIG. 2 depicts fluorinated esters for use as diluents: 2,2,3,3-tetrafluoropropyl trifluoroacetate (TFPTFA) and 1,1,1,3,3,3-hexafluoroisopropyl trifluoroacetate (HFITFA) in accordance with one embodiment; and

FIG. 3 depicts fluorinated ethers for use as diluents: 1,1,2,2-tetrafuoroethyl 2,2,2-trifuoroethyl ether (TFETFE) and 1H, 1H, 5H-octafluoropentyl 1,1,2,2-tetrafluoroethyl ether (OFPTFE) in accordance with one embodiment.

### DETAILED DESCRIPTION

The foregoing summary, as well as the following detailed description of certain embodiments of the present invention, will be better understood when read in conjunction with the appended drawings.

The following detailed description should be read with reference to the drawings in which similar elements in different drawings are numbered the same. The drawings, which are not necessarily to scale, depict illustrative embodiments and are not intended to limit the scope of the invention.

One or more embodiments relate to electrolyte compositions and methods of using the electrolyte compositions in batteries. The compositions include localized high concentration electrolytes (LHCEs) for the operation of Li-ion batteries. The LHCEs include a salt, a solvent, and a diluent. The LHCEs provide a high concentration electrolyte diluted with inert, non-coordinating solvents; the distinct solvation structure of LHCEs imparts non-flammability, a wide operating temperature range, and/or an improved interfacial stability, depending on the formulation.

Li-ion batteries (LIBs) are increasingly required to operate under a broad range of operational conditions which push the limits of the current state of the art. Extreme conditions of high operating voltage, wide temperature range, fast charge, and intense abuse present problems with stability and safety, primarily due to the limitations of traditional Li-ion carbonate based electrolytes. Thus, there is a critical need to develop novel electrolytes with functionality under this diverse set of environments and operating parameters.

Accordingly, embodiments of the invention described herein provide localized high concentration electrolytes based on fluorinated esters that enable cycling of Li-ion cells under an array of extreme conditions. The composition represents the first application of the LHCE concept with fluorinated esters, which permits operation of Li-ion batteries under the following conditions:

(1) high voltage—high oxidative stability of the fluorinated esters, imparted by the electron withdrawing effect of the fluorine substituents enable the electrolytes to be used at high voltages;

(2) wide temperature range—fluorinated esters have low viscosity at low temperatures and by incorporating the solvents into an LHCE, strong interactions between more polar fluorinated esters are broken by diluting with less polar variants, increasing the conductivity at low temperature. At high temperatures, LiF rich interphases imparted by the LHCE improve the thermal stability at both the anode and cathode;

(3) fast charging—fast Li+ de-solvation kinetics at the graphite/electrolyte interface are critical for fast charging;

(4) High capacity electrodes—the new electrolytes facilitate and enable the adoption of high capacity electrode-based conversion reactions such as silicon, metal oxides, metal fluorides, and other systems that involve multiple electron transfers and significant volume change. Fluorinated esters have lower Li+ binding energies than that of typical conventional carbonate solvents, which enable more rapid de-salvation kinetics and thus improved fast charge electrochemistry; and

(5) low flammability—incorporation of a non-flammable fluorinated ester diluents into the LHCEs reduces or eliminates the flammability of the electrolyte.

The compositions include:

(1) an active salt;

(2) solvents for which the active salt is soluble; and

(3) diluents for which the active salt has low solubility. Various additional additives that facilitate the formation of interphases on the active electrodes within battery components may also be included in the LHCE formulations where the additives would be present in the total mixture.

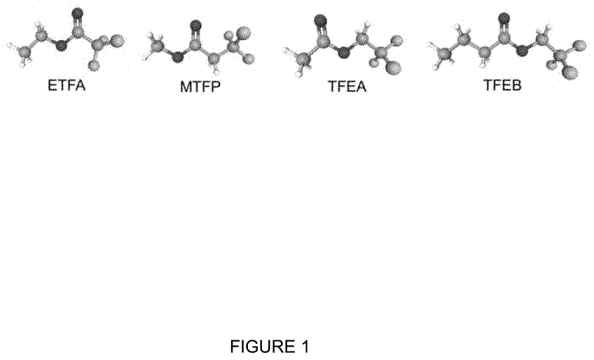

FIG. 1 illustrates fluorinated esters for use as LHCE solvents: ethyl 2,2,2-trifluoroacetate (ETFA), methyl 3,3,3-triflouropropionate (MTFP), 2,2,2-trifluoroethyl acetate (TFEA), and 2,2,2-trifluoroethylbutyrate (TFEB).

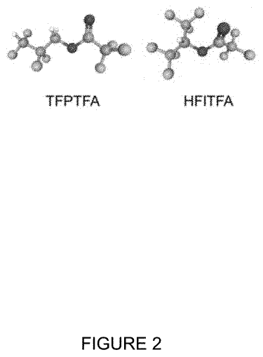

FIG. 2 illustrates fluorinated esters for use as diluents: 2,2,3,3-tetrafluoropropyl trifluoroacetate (TFPTFA) and 1,1,1,3,3,3-hexafluoroisopropyl trifluoroacetate (HFITFA).

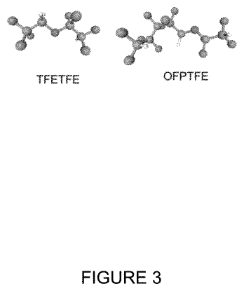

FIG. 3 illustrates fluorinated ethers for use as diluents: 1,1,2,2-tetrafuoroethyl 2,2,2-trifuoroethyl ether (TFETFE) and 1H, 1H, 5H-octafluoropentyl 1,1,2,2-tetrafluoroethyl ether (OFPTFE).

Solvent selection. Fluorinated esters ETFA, MTFP, TFEA and TFEB (See FIG. 1) with a single trifluoromethyl group are used as base solvents for the high concentration electrolyte. ETFA and MTFP have recently demonstrated excellent low temperature (<−20° C.) performance in Li/NMC 811 and Li/LMO cells due to low viscosity and melting point, yielding high ionic conductivity at low temperatures, as well as high anodic stability. Additionally, fluorinated esters ETFA, TFEA, and TFEB have been demonstrated as effective co-solvents in carbonate-based electrolytes for improving delivered capacity at low temperatures. The four solvents have boiling points of 60, 78, 93, and 113° C. for ETFA, TFEA, MTFP, and TFEB, respectively. The shorter chain ETFA may have the potential for improvement in conductivity at low temperatures, but at the possible expense of high-temperature stability due to the greater volatility. On the other hand, TFEB with the highest boiling point has demonstrated reduced degradation when used as an additive to carbonate-based electrolytes. The fluorinated ester solvents described herein are commercially available with solvent costs competitive with or less than fluorinated carbonates and hydrofluoroethers used in other reported fluorinated LHCEs.

Diluent selection. TFPTFA and HFITFA (See FIG. 2) with multiple fluoroalkyl groups are used as the diluents for the compositions. They are anticipated to prevent disruption of the solvation structure of the LHCE, preserving its beneficial properties, while reducing viscosity and improving wettability. Solution behavior of the diluents depends on the strength of the inductive effect of electron-withdrawing fluoroalkyl groups, contingent upon both the degree of fluorination and proximity of the fluoroalkyl groups to the Li-coordinating oxygen atoms of the ester group. It should be appreciated that HFITFA with greater electron-withdrawing strength will have a lower solvating ability, best preserving the qualities of the high concentration electrolyte, but by extension may also have lower conductivity. It is also noted that both the TFPTFA and HFITFA solvents are non-flammable, thus, depending on the dilution ratio, the possibility exists to prepare electrolytes with low or no flammability.

Diluents may also be selected using compounds from the class of materials including fluorinated ethers: 1,1,2,2-tetrafuoroethyl 2,2,2-trifuoroethyl ether (TFETFE) and 1H, 1H, 5H-octafluoropentyl 1,1,2,2-tetrafluoroethyl ether (OFPTFE) These materials are shown in FIG. 3.

Salt selection: The salt may be selected from lithium hexafluorophosphate (LiPF₆) or lithium bis(fluorosulfonyl)imide LiFSI.

Film-forming Additives: The use of an LHCE forms a robust and uniform SEI on the graphite surface via decomposition of the LiPF₆ salt in the EC-free electrolyte. The potential for further improvement of the interfacial properties at the anode can be explored by incorporating film-forming additives fluoroethylene carbonate (FEC) and vinylene carbonate (VC) at low percentages (<10%) into the LHCE.

Electrolyte formulation methodology: Local high concentration electrolytes are prepared by first dissolving LiPF₆ or LiFSI salt in ETFA, MTFP, TFEA, and TFEB solvents, until the maximum dissolved concentration is achieved. The HCEs are then diluted using fluorinated esters having greater fluorine substitution—TFETFA and HFITFA. Film-forming additives FEC and VC at low concentrations may also be added if they are found to improve SEI stability.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are within the scope of the spirited embodiments as recited in the appended claims. Additionally, the recited order of the elements or sequences, or the use of numbers, letters, or other designations therefor, is not intended to limit the claimed processes to any order except as may be specified. All ranges disclosed herein also encompass all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. A composition comprising:
a solvent comprising a first fluorinated ester;
a diluent; and
a salt.

2. The composition of claim 1 further including a film-forming additive.

3. The composition according to claim 1 wherein the diluent is selected from a second fluorinated ester or a fluorinated ether.

4. The composition according to claim 1, wherein the first fluorinated ester is selected from ethyl 2,2,2-trifluoroacetate (ETFA), methyl 3,3,3-triflouropropionate (MTFP), 2,2,2-trifluoroethyl acetate (TFEA), and 2,2,2-trifluoroethylbutyrate (TFEB).

5. The composition according to claim 3, wherein the diluent is selected from the fluorinated esters 2,2,3,3-tetrafluoropropyl trifluoroacetate (TFPTFA) and 1,1,1,3,3,3-hexafluoroisopropyl trifluoroacetate (HFITFA) or the fluorinated ethers 1,1,2,2-tetrafuoroethyl 2,2,2-trifuoroethyl ether (TFETFE) and 1H, 1H, 5H-octafluoropentyl 1,1,2,2-tetrafluoroethyl ether (OFPTFE).

6. The composition according to claim 1 wherein the salt is selected from lithium hexafluorophosphate (LiPF₆) or lithium bis(fluorosulfonyl)imide LiFSI.

7. The composition according to claim 2 wherein the film-forming additive is selected from fluoroethylene carbonate (FEC) or vinylene carbonate (VC).

8. The composition according to claim 1 wherein an solvent to diluent ratio is from about 1:0.2 to about 1:10.

9. An electrolyte comprising:
a first fluorinated ester;
a diluent selected from a second fluorinated ester or a fluorinated ether; and
at least one of a salt and a film-forming additive, wherein the solvent to diluent ratio is from about 1:0.2 to about 1:10.

10. The composition according to claim 9, wherein the first fluorinated ester is selected from ethyl 2,2,2-trifluoroacetate (ETFA), methyl 3,3,3-triflouropropionate (MTFP), 2,2,2-trifluoroethyl acetate (TFEA), and 2,2,2-trifluoroethyl butyrate (TFEB).

11. The composition according to claim 10, wherein the diluent is selected from the fluorinated esters 2,2,3,3-tetrafluoropropyl trifluoroacetate (TFPTFA) and I,I,1,3,3,3-hexafluoroisopropyl trifluoroacetate (HFITFA) or the fluorinated ethers 1,1,2,2-tetrafuoroethyl 2,2,2-trifuoroethyl ether (TFETFE) and 1H, 1H, 5H-octafluoropentyl 1,1,2,2-tetrafluoroethyl ether (OFPTFE).

12. The composition according to claim 11 wherein the salt is selected from lithium hexafluorophosphate (LiPF₆) and lithium bis(fluorosulfonyl)imide LiFSI.

13. The composition according to claim 11 wherein the film-forming additive is selected from fluoroethylene carbonate (FEC) and vinylene carbonate (VC).

14. A lithium-ion battery comprising an electrolyte comprising:
a solvent comprising a first fluorinated ester;
a diluent;
and at least one of a salt and a film-forming additive.

15. The battery according to claim 14 wherein the diluent comprises a second fluorinated ester or a fluorinated ether.

16. The battery according to claim 14, wherein the first fluorinated ester is selected from ethyl 2,2,2-trifluoroacetate (ETFA), methyl 3,3,3-triflouropropionate (MTFP), 2,2,2-trifluoroethyl acetate (TFEA), and 2,2,2-trifluoroethylbutyrate (TFEB).

17. The battery according to claim 14, wherein the diluent is selected from the fluorinated esters 2,2,3,3-tetrafluoropropyl trifluoroacetate (TFPTFA) and I,I,1,3,3,3-hexafluoroisopropyl trifluoroacetate (HFITFA) or the fluorinated ethers 1,1,2,2-tetrafuoroethyl 2,2,2-trifuoroethyl ether (TFETFE) and 1H, 1H, 5H-octafluoropentyl 1,1,2,2-tetrafluoroethyl ether (OFPTFE).

18. The battery according to claim 14 wherein the salt is selected from lithium hexafluorophosphate (LiPF₆) and lithium bis(fluorosulfonyl)imide LiFSI.

19. The battery according to claim 14 wherein the film-forming additive is selected from fluoroethylene carbonate (FEC) or vinylene carbonate (VC).

20. The battery according to claim 14 wherein the solvent to diluent ratio is from about 1:0.2 to about 1:10.
